(19) United States
(12) Patent Application Publication
(10) Pub. No.: US 2013/0266702 A1
(43) Pub. Date: Oct. 10, 2013

(54) GRILLED CHEESE SANDWICH FOR THE TOASTER

(71) Applicant: General Mills, Inc., Minneapolis, MN (US)

(72) Inventors: John ENGSTROM, St. Paul, MN (US); Eva KAUSTINEN, Minneapolis, MN (US)

(21) Appl. No.: 13/856,570

(22) Filed: Apr. 4, 2013

Related U.S. Application Data
(63) Continuation of application No. 12/971,318, filed on Dec. 17, 2010, now abandoned.
(60) Provisional application No. 61/290,735, filed on Dec. 29, 2009.
(60) Provisional application No. 61/298,766, filed on Jan. 27, 2010.

(51) Int. Cl. A23L 1/01

(52) U.S. Cl. CPC A23L 1/0128
USPC 426/275

(57) ABSTRACT

A freezable, toaster reheatable grilled cheese sandwich, and a method for making this type of sandwich, are described. The grilled cheese sandwich has organoleptic properties that are identical or substantially identical to a homemade, made-from-scratch grilled cheese sandwich.

### CROSS-REFERENCE TO RELATED APPLICATIONS

This application claims the benefit of priority under 35 U.S.C. 119(e)(1) of provisional patent applications Ser. No. 61/290,735, filed Dec. 29, 2009 and Ser. No. 61/298,766, filed Jan. 27, 2010.

### BACKGROUND OF THE INVENTION

Convenience food products are very popular with today's consumers. These types of products have been available to consumers for many years, and over time, consumers have come to expect high quality products that have organoleptic properties that are very similar to traditional, made-from-scratch or homemade food products.

Consumer food product manufacturers are faced with the dilemma of providing these desired organoleptic properties in a food product that is easy to prepare and consume by the consumer, and which can also be efficiently manufactured, distributed and sold at the retail or foodservice level. In many cases, the realities of commercial food processing and distribution have required the use of food ingredients or processing methods that detract from the food product's desired organoleptic characteristics. For example, preservatives or other non-traditional ingredients may need to be added to the food product for food safety or stability concerns, or the food processing steps, such as crimping or sealing, may result in the appearance, texture or other attributes of the food product to be altered such that they no longer resemble a homemade or made-from-scratch product. It remains a challenge, therefore, for food product manufacturers to provide convenient food products that replicate the qualities associated with a traditional homemade or made-from-scratch product.

One category of convenience food products is the hand-held meal category, which includes sandwiches, pockets, filled dough products, and the like. There are several products currently on the market that utilize some sort of dough-based sealed encasement containing a filling material. These products are typically heated in a microwave oven, often with a susceptor to facilitate browning of the outer crust. Other products in this category may not require heating, such as ready-to-eat peanut butter sandwiches. While these products are convenient for the consumer, they typically do not resemble made-from-scratch or homemade products in appearance, taste, texture and other organoleptic properties. It remains a challenge to the commercial food product manufacturer to replicate these homemade, made-from-scratch organoleptic properties on a large scale manufacturing line.

### SUMMARY OF THE INVENTION

The present invention is directed to a toaster reheatable sandwich product comprising at least two bread layers, in between which a cheese layer or other food component layer is sandwiched. The sandwich is heated to a melting temperature of the cheese or other food component. The heated sandwich is then compressed using a dual compression belt apparatus to apply sufficient pressure to the sandwich to cause the cheese or other food component layer to adhere to the inner surface of each bread layer to form the sandwich product. The sandwich product of the present invention retains the layered appearance of a traditional made-from-scratch sandwich.

### BRIEF DESCRIPTION OF THE DRAWING

FIG. 1 is a schematic diagram of the process of the present invention.

### DETAILED DESCRIPTION OF THE INVENTION

The present invention is directed to sandwiches or other hand-held meals (hereinafter collectively referred to as “sandwich product” or “sandwich products”) that are designed to be reheated from a frozen state by the consumer in a toaster prior to consumption. The process of making these sandwich products results in a product that closely resembles a homemade product. The sandwich product is capable of being made on a large scale commercial food processing line substantially without losing the desired organoleptic properties of a traditional homemade or made-from-scratch product.

One embodiment of the sandwich product of the present invention is a grilled cheese sandwich. The grilled cheese sandwich of the present invention starts with the typical made-from-scratch ingredients, namely, at least two layers of untoasted bread, preferably in the form of slices, in between which is sandwiched a portion, such as a slice, of cheese. Those skilled in the art will understand that this sandwich assembly can be achieved using known food processing equipment and methods.

Once the sandwich is assembled, it is conveyed to a belt oven, such as an impingement oven available from Middleby Marshall Corporation of Elgin, Ill. In the belt oven, both sides of the sandwich are heated at the same time to toast the exterior surface of the bread slices and to at least initiate melting of the cheese layer sandwiched between the bread layers. Other alternative types of cooking methods may be used as long as the outer surfaces of the bread layers are toasted and the cheese layer is melted to some degree.

The bread layers of the sandwich are heated to a temperature sufficient to toast the exterior surfaces of bread layers without burning them. The degree of toasting should be similar to the degree of toasting a slice of bread in a toaster. One parameter for determining whether the bread is sufficiently toasted is the degree of moisture loss. In some embodiments of the present invention, it was found that a moisture loss of between about 10% to about 25%, such as between about 12% to about 22%, upon exiting the belt oven resulted in sufficiently toasting the exterior surfaces of the bread and providing the mouthfeel of a homemade grilled cheese sandwich.

The cheese layer is preferably heated to at least its melt onset temperature, and may be heated to its melt point temperature. As used herein, these temperatures may collectively or individually be referred to as a “melting temperature.” A summary of melt onset and melt point temperatures for a variety of cheese products is shown in Table 1:

TABLE 1

| | | |
|---|---|---|
| Kraft ® Velveeta ® Singles | 101 | 121 |
| Kraft ® Singles | 108 | 127 |
| Schreiber Sharp Cheddar | 109 | 171 |
| Schreiber American | 110 | 155 |
| Kraft ® Deli Deluxe ® Melt Profile | 115 | 150 |
| Land O'Lakes ® American | 118 | 152 |
| Kraft ® Shredded Cheese | 129 | 138 |

In one embodiment, the temperature of the cheese layer upon exiting the belt oven is between about 100° F. and about 140° F. Other ranges of temperatures that are suitable in the process of the present invention are between about 105° F. to about 130° F., or 110° F. to about 125° F. In one embodiment, the average temperature of the cheese layer upon exiting the belt over is about 120° F.

Once the sandwich exits the oven, it is conveyed to a dual compression belt apparatus to apply pressure to the sandwich while the sandwich is still warm. Upper and lower compression belts are spaced apart from each other at a distance sufficient to apply pressure to the sandwich to cause the cheese layer to bond with the inner surface of each bread slice. In one embodiment, the distance between the upper and lower compression belts is between about 1.5 cm to about 3.0 cm. Other methods of applying pressure to the upper and lower layers of the sandwich may also or alternatively be used. The bonding between the cheese layer and the slices of bread operates to keep all the sandwich components together during subsequent processing, freezing, storage, distribution and reheating.

It was surprisingly found that upon applying pressure to the sandwich after heating the sandwich to the temperature ranges described above, it is possible to have the cheese layer bond the sandwich together without having the cheese layer flow out of the sandwich during compression. As used herein, the expression “flow out” shall refer to the cheese or other food component coming out of the sandwich product to such a degree that the cheese or other food component loses contact with the bread layer or layers.

Previous attempts at commercially manufacturing a hand-held cheese-filled product have required the use of sealants to seal a cheese filling within an outer dough or bread layer, or enrobing or encasing a cheese filling entirely within dough or bread product, neither of which provides the desired layered appearance of a traditional sandwich. Other methods have simply formed a cheese sandwich, without melting the cheese at all during the manufacturing process, to avoid the problems associated with cheese flowing out of the sandwich, but this alternative requires a longer heating time by the consumer and is therefore not as convenient.

By utilizing the process of the present invention, it is possible to melt the cheese during the manufacturing process and retain the layered appearance of a traditional made-from-scratch grilled cheese sandwich in the sandwich product of the present invention. In fact, it is desirable to have at least a portion of the cheese layer visible between the bread slices from the outside of the sandwich product, and surprisingly, the process of the present invention is able to achieve this layered appearance without causing the cheese layer to flow out of the sandwich during processing or subsequent reheating.

While not intending to be bound by theory, it is believed that heating the cheese layer to a temperature sufficient to initiate melting but not to completely melt the cheese, the viscosity of the cheese at these temperatures allows the cheese layer to bond to the bread layers but not flow out of the sandwich. As such, sealing the bread around the cheese, or encasing the cheese within the bread, is not necessary, so the resulting product appears identical or almost identical to a traditional homemade or made-from-scratch product. In some embodiments, the cheese layer bonds to the bread layers and does not flow out of the sandwich product at a viscosity of between about 1300 Pa·S to about 300 Pa·S, such as between about 1236 Pa·S to about 348 Pa·S, when heated to a temperature of between about 100° F. to about 145° F., such as between about 105° F. to about 135° F., as measured using a controlled stress rheometer equipped with a parallel plate geometry, available from TA Instruments of New Castle, Del.

After exiting the dual compression belt apparatus, an optional layer of butter may be applied to one or both surfaces of the sandwich product. The butter layer can be applied using a sprayer or other conventional equipment familiar to those of skill in the art. The butter layer primarily adds to the flavor profile of the sandwich product, since butter is often used on the outer surfaces of made-from-scratch grilled cheese sandwiches. In addition, the butter layer helps to evenly distribute heat when the sandwich product is reheated by the consumer in a toaster.

After the optional butter layer is applied, the sandwich product can be wrapped and frozen using conventional food processing equipment, and is ready for storage or distribution to retail or foodservice outlets.

The consumer can simply remove the wrapped sandwich product from the freezer, remove the wrapping material, and place the sandwich product in a conventional vertical toaster, toaster oven, or conventional oven (hereinafter collective referred to as “toaster”) for reheating prior to consumption. Due to variations in toaster capabilities, one or more toasting cycles may be needed to achieve a suitable eating temperature throughout the product. Alternatively, the sandwich product may be reheated using a combination of a toasting step and a microwaving step, or simply a microwaving step, although it is preferable to use a toaster for at least part of the reheating process to achieve the desired texture and mouthfeel of a grilled cheese sandwich. It was surprisingly discovered that even with more than one toasting cycle, the cheese layer of the sandwich product did not flow out of the product. Upon removal from the toaster, in some embodiments at least a portion of the layer of cheese is clearly visible along the outer perimeter of the sandwich product, closely resembling a made-from-scratch grilled cheese sandwich.

Although a grilled cheese sandwich is described, the present invention contemplates any type of food component capable of being sandwiched between at least two layers of bread and forming a bond to the inner surface of each bread layer. Examples of food components suitable for use in the present invention include, but are not limited to, cheese, meat, vegetables, fruits, legumes, peanut butter or other nut or seed butters, hummus, dips, spreads, sauces, pastes, jams, jellies, and the like. Examples of cheese suitable for use in the present invention include, but are not limited to, processed cheese products, American cheese, real cheese, spreadable cheese, sprayable cheese, pumpable cheese, cream cheese, cheese blends, cheese sauce, and the like.

The amount of the food component layered between the bread layers can vary depending on the food component and the desired finished product. In general, the amount of the food component should be sufficient to bond the bread layers together. In one embodiment, it was found that between about 15 g to about 30 g, such a as about 19 g to 28 g, of cheese is suitable for use in the sandwich product of the present invention. In another embodiment, it was found that a cheese to bread ratio of between about 1:2 to about 3:4 is suitable for use in the present invention.

Any type of bread or cooked or par-cooked dough product suitable for being frozen and then reheated in a toaster may be used. As used herein, “bread” refers to any dough-based product capable of sandwiching or otherwise partially enclosing the food component layer. The size and thickness of the bread layer may be selected such that the upper and lower bread layers, together with the middle food component layer, following the compression step can fit within a conventional vertical toaster slot for reheating. Generally, a bread slice having a thickness of between about 0.3 cm and about 1.5 cm, such as between about 0.5 cm and 1.3 cm, a width of between about 8 cm and 14 cm, such as between about 10 cm and 11.55 cm, and a height of between about 8 cm and 14 cm, such as between about 9.5 cm and 11 cm, are suitable for use in the present invention.

The following examples are intended to further describe, but not limit, the product and process of the present invention.

### EXAMPLE 1

### Process for Making a Sandwich Product

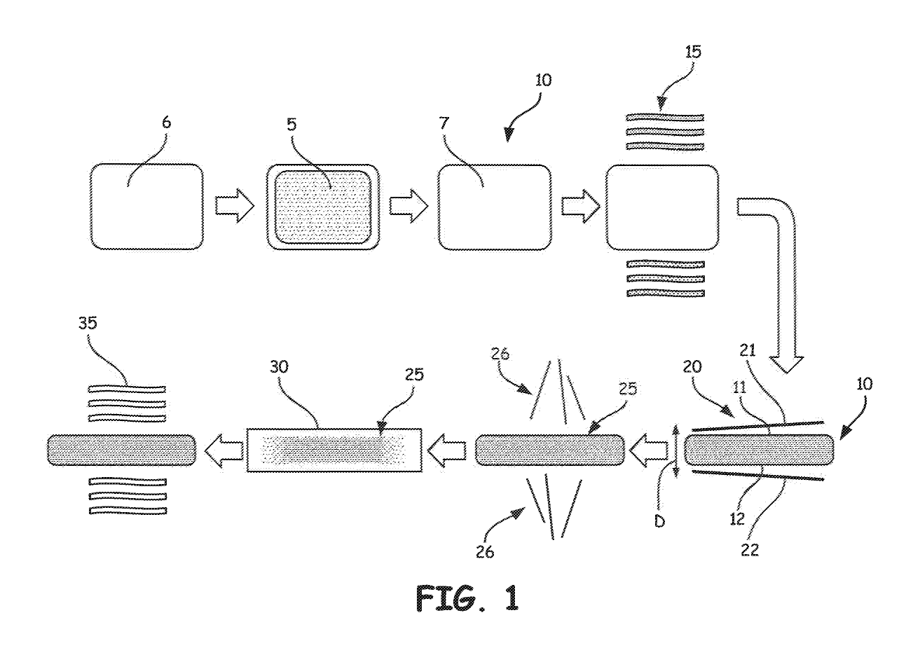

FIG. 1 is a diagram representing the process of the present invention. Cheese slice 5 is sandwiched between bread layers 6 and 7 to make sandwich 10. After the sandwich 10 is assembled, it is conveyed to a belt oven 15. The oven temperature and dwell time within the oven can be adjusted to accommodate the melting profile of the cheese layer and the toasting properties of the bread layers.

After being heated in the belt oven, the sandwich is conveyed through a compression belt apparatus 20 to apply pressure to the sandwich while it is still warm. The distance D between the compression belts 21 and 22 is selected to provide pressure on the outer surfaces 11 and 12 of sandwich 10. The pressure is sufficient to cause cheese slice 5, after being heated, to form a bond with inner surfaces 13 and 14 of bread layers 6 and 7 to result in sandwich product 25 of the present invention.

Sandwich product 25 can be optionally sprayed or coated with a butter spray 26 on one or both outer surfaces 11 and 12. Then sandwich product 25 is wrapped with a food grade wrapping material 30, and conveyed to a freezer apparatus 35.

Using the process of Example 1, the following products embodying the present invention were made.

### EXAMPLE 2

### Grilled Cheese Sandwich Product

A pasteurized process American cheese in accordance with 21 C.F.R. §133.169 was used to make a grilled cheese sandwich product. The cheese had a melt onset temperature of 110° F. and a melt point temperature of 155° F. A 23.5 g layer of cheese was sandwiched between two slices of white bread, each slice having a thickness of about 0.95 cm. The bread had an initial moisture content of 40-45%.

The sandwiched cheese and bread slices were conveyed to a belt oven heated to 520° F. The sandwich was held at that temperature for 2 minutes. Upon exiting the oven, the temperature of the cheese layer was 119° F. and the moisture content of the bread slices was between about 22.5% to 27.5%, reflecting about a 17.5% moisture loss. The heated sandwich was then conveyed through a compression belt having a final belt distance of 1.9 cm to result in the sandwich product of the present invention.

The sandwich product was then sprayed with 8.5 g of butter spray on each side. A biofilm wrapper was then wrapped and sealed around the product, and the wrapped sandwich product was conveyed to a spiral freezer having a temperature of about −10° F. for storage.

After freezing, the frozen wrapped sandwich product was removed from the freezer, unwrapped, and heated in a conventional toaster set to the medium-low setting for one to two toasting cycles, until the center of the sandwich product reached a temperature of 130° F. The heated sandwich product was removed from the toaster, and had a grilled, layered appearance substantially identical to a homemade made from scratch grilled cheese sandwich. Upon consumption, the bread had a crispy, toasted exterior and a tender interior, and the cheese was sufficiently melted to replicate the melted cheese quality of a homemade product.

### EXAMPLE 3

### Grilled Ham and Cheese Sandwich Product

A sandwich product was made as described in Examples 1 and 2, but a 16 g slice of cooked ham was added on top of the cheese layer, leaving about a 0.47 cm to 1 cm border of exposed cheese around the outer perimeter of the ham slice, before being topped with a second slice of bread. The sandwich was processed in substantially the same way as described in Examples 1 and 2. The exposed cheese border is sufficient to bond the bread slices together in the same fashion as Examples 1 and 2, and at the same time prevents the ham slice from moving out of the sandwich.

Upon toasting at the medium-low setting for one to two cycles, the sandwich product exhibited desirable organoleptic properties substantially identical to a made-from-scratch grilled ham and cheese sandwich.

### EXAMPLE 4

### Pizza Sandwich Product

A sandwich product was made as described in Examples 1 and 2, but a 23 g slice of mozzarella cheese was used as the cheese layer, and 8-10 g of pizza sauce was added on top of the cheese layer. The pizza sauce was applied on top of the cheese layer in a manner to leave a 0.47 cm-1 cm border of exposed cheese along the outer perimeter of the pizza sauce, before being topped with a second slice of bread. The sandwich was processes in substantially the same way as described in Examples 1 and 2. The exposed cheese border is sufficient to bond the bread slices together in the same fashion as Examples 1 and 2, and at the same time prevents the sauce from flowing out of the sandwich in the toaster.

Upon toasting the pizza sandwich product at the medium-low setting for one to two cycles, the sandwich product exhibited desirable organoleptic properties.

While the foregoing description and examples describe and enable the present invention, they in no way serve to limit the scope of the present invention. Those skilled in the art will appreciate that many other modifications, variations and alternative embodiments of the present invention are possible within the full scope of the present invention, which is set forth in the following claims.

1. A process for providing a layered appearance of a traditional grilled cheese sandwich to a toaster reheatable grilled cheese sandwich product comprising at least two layers of bread and a cheese layer, said process consisting essentially of the steps of:
placing the cheese layer between the at least two layers of bread to create a cheese sandwich;
heating the cheese sandwich on both sides of the sandwich to a level such that the cheese layer reaches a temperature inside the sandwich of between about 100° F. and about 145° F. to achieve a viscosity of between about 1300 Pa·S to about 300 Pa·S thereby melting the cheese layer substantially without the cheese layer flowing out of the sandwich, to make a heated cheese sandwich; and
conveying the heated cheese sandwich through a compression belt apparatus to apply pressure to the cheese sandwich to facilitate adhesion between the cheese layer and the inner surface of each bread layer and such that at least a portion of the cheese layer is visible along an outer perimeter of the sandwich product to provide the layered appearance of the traditional grilled cheese sandwich to the toaster reheatable grilled cheese sandwich product.

2. The process of claim 1, further comprising freezing the sandwich after applying pressure to the sandwich.

3. The process of claim 1, wherein the heating is sufficient to toast an outer surface of each slice of bread.

4. The process of claim 1, wherein the heated cheese sandwich is conveyed to a dual compression belt apparatus comprising an upper compression belt and a lower compression belt.

5. The process of claim 1, further comprising applying a layer of butter on an outer surface of at least one slice of bread after applying pressure to the sandwich.

6. (canceled)

7. The process of claim 1, wherein the cheese sandwich is heated to a degree sufficient to provide about a 10% to about 25% moisture loss in the bread layers.

8. The process of claim 4, wherein the upper compression belt is spaced apart from the lower compression belt by a distance of between about 1.5 cm to about 3.0 cm.
